(19) United States
(12) Patent Application Publication
(10) Pub. No.: US 2015/0061320 A1
(43) Pub. Date: Mar. 5, 2015

(54) VEHICLE BODY FRAME STRUCTURE OF MOTOR VEHICLE

(71) Applicant: HONDA MOTOR CO., LTD., MINATO-KU, TOKYO (JP)

(72) Inventors: Tomoya Yabu, Wako-shi (JP); Shigeto Yasuhara, Wako-shi (JP)

(73) Assignee: Honday Motor Co., Ltd., Minato-ku, Tokyo (JP)

(21) Appl. No.: 14/371,285

(22) PCT Filed: Dec. 17, 2012
(86) PCT No.: PCT/JP2012/082634

§ 371 Date: Jul. 9, 2014

(30) Foreign Application Priority Data
Jan. 10, 2012 (JP) 2012-001934
Jan. 10, 2012 (JP) 2012-001935
Jan. 10, 2012 (JP) 2012-001936

(51) Int. Cl. B60R 19/34; B60R 19/18; B62D 25/08; B60R 19/03

(52) U.S. Cl. CPC B60R 19/34; B60R 19/03; B60R 19/18; B62D 25/082; B60R 2019/1846; B60R 2019/247
USPC 296/187.1; 293/133

(57) ABSTRACT

In a vehicle body frame structure, a bumper beam extending in the vehicle width direction, and lower members extending forwardly from the front ends of upper members, are connected to the front ends of bumper beam extensions, which are made of a fiber-reinforced resin and extend forwardly from front ends of front side frames, and the front end faces of the pair of left and right bumper beam extensions, and the front face of the bumper beam are curved into a U-shape pointing toward the front of the vehicle body. Thus, is it possible to reduce the weight of the vehicle body frame in the front part of the motor vehicle, to transmit to the bumper beam extensions a collision load inputted even into the bumper beam or inputted even into the front parts of the lower members, and to reduce the dimensions of the vehicle body front part.

### TECHNICAL FIELD

The present invention relates to a vehicle body frame structure of a motor vehicle, the structure including a pair of left and right front side frames, a pair of left and right bumper beam extensions, a bumper beam, a pair of left and right upper members, and a pair of left and right lower members.

### BACKGROUND ART

An arrangement in which a metal frame module is disposed in front of a dashboard, a crash rail, made of an FRP, is disposed in front of the metal frame module, and when a vehicle is involved in a frontal collision the resin is separated from the fiber of the crash rail by means of the collision load to thus absorb collision energy is known from Patent Document 1 below.

Furthermore, an arrangement in which a crash rail, made of an FRP, is formed into a pyramidal shape having a closed cross-section, the cross-sectional area gradually increasing from the front end toward the rear end, and when a collision load is inputted the crash rail crumples sequentially from the extremity side so as to absorb collision energy is known from Patent Document 2 below.

### RELATED ART DOCUMENTS

### Patent Document

Patent Document 1: GB Patent No. 2367270
Patent Document 2: U.S. Pat. No. 6,406,088

### SUMMARY OF THE INVENTION

### Problems to be Solved by the Invention

When a vehicle is involved in a frontal collision and the collision load is inputted into a bumper beam, it is possible to transmit the collision load from the bumper beam to a crash rail (bumper beam extension) and absorb it, but when a vehicle is involved in a narrow offset frontal collision and the collision load is inputted further outside in the vehicle width direction than the bumper beam extension, there is a possibility that the collision load will not be able to be efficiently transmitted to the bumper beam extension. In order to solve this problem, the bumper beam may be made to project toward the outside in the vehicle width direction from the front ends of a pair of left and right bumper beam extensions, but this causes the problem that the bumper beam protrudes forward and outward in the vehicle width direction to thus increase the dimensions of the vehicle body front part.

The present invention has been accomplished in light of the above circumstances, and it is an object thereof to absorb a collision load effectively either in the case of a frontal collision or in the case of a narrow offset frontal collision while avoiding any increase in the dimensions of a vehicle body front part.

### Means for Solving the Problems

In order to attain the above object, according to a first aspect of the present invention, there is provided a vehicle body frame structure of a motor vehicle, the structure comprising a pair of left and right front side frames extending from a lower part of a front wall part of a cabin toward a front of a vehicle body, a pair of left and right bumper beam extensions, made of a fiber-reinforced resin, extending from a front end of the front side frame toward the front of the vehicle body, a bumper beam, made of a fiber-reinforced resin, extending in a vehicle width direction and connected to front ends of the pair of left and right bumper beam extensions, a pair of left and right upper members extending from an upper part at an outer end in the vehicle width direction of the front wall part of the cabin toward the front of the vehicle body, and a pair of left and right lower members, made of a fiber-reinforced resin, extending, while bending, from front ends of the pair of left and right upper members downwardly toward the front, forwardly and inwardly in the vehicle width direction and connected to the front ends of the pair of left and right bumper beam extensions, wherein front faces and outer faces in the vehicle width direction of the pair of left and right lower members and a front face of the bumper beam are curved into a U-shape pointing toward the front of the vehicle body when viewed from above.

Further, according to a second aspect of the present invention, in addition to the first aspect, the bumper beam is connected to inner walls in the vehicle width direction at the front ends of the pair of left and right bumper beam extensions, the pair of left and right lower members are connected to outer walls in the vehicle width direction at the front ends of the pair of left and right bumper beam extensions, and the front faces and the outer faces in the vehicle width direction of the pair of left and right lower members, front end faces of the pair of left and right bumper beam extensions, and the front face of the bumper beam are curved into a U-shape pointing toward the front of the vehicle body when viewed from above.

Furthermore, according to a third aspect of the present invention, in addition to the first or second aspect, a bumper beam support portion supporting the outer end in the vehicle width direction of the bumper beam is provided on an inner face in the vehicle width direction of the front end part of the bumper beam extension, and a lower member support portion supporting a front end, bent inwardly in the vehicle width direction, of the lower member is provided on an outer face in the vehicle width direction of the front end part of the bumper beam extension.

Moreover, according to a fourth aspect of the present invention, in addition to any one of the first to third aspects, a weak portion is provided in the front end part of the bumper beam extension.

Further, according to a fifth aspect of the present invention, in addition to any one of the first to fourth aspects, the bumper beam, the lower member and the bumper beam extension comprise a main body part having an open cross section and a rib connecting inner faces of the main body part, the main body part is formed by hardening continuous fibers with a resin, and the rib is formed by hardening discontinuous fibers with a resin.

Furthermore, according to a sixth aspect of the present invention, in addition to the fifth aspect, the bumper beam and the lower member comprise a plurality of vertical ribs in an interior of the main body part having a squared U-shaped cross section.

Moreover, according to a seventh aspect of the present invention, in addition to the fifth aspect, the bumper beam extension comprises a plurality of X-shaped ribs in an interior of the main body part having an S-shaped cross section.

Further, according to an eighth aspect of the present invention, in addition to any one of the first to seventh aspect, a width in a vertical direction of the bumper beam is larger in a middle part in the vehicle width direction than in an end part in the vehicle width direction.

Furthermore, according to a ninth aspect of the present invention, in addition to the first aspect, the main body part of the bumper beam extension is formed so as to have an S-shaped cross section while comprising a first side wall, a second side wall and a third side wall, which are disposed substantially parallel to each other, a first bottom wall connecting end parts on one side of the first side wall and the second side wall, and a second bottom wall connecting end parts on the other side of the third side wall and the second side wall, the first side wall, the first bottom wall and the second side wall being connected via a first rib forming an X-shape when viewed in the vehicle width direction, and the third side wall, the second bottom wall and the second side wall being connected via a second rib forming an X-shape when viewed in the vehicle width direction.

Moreover, according to a tenth aspect of the present invention, in addition to the ninth aspect, the main body part of the bumper beam extension is formed from a continuous fiber-reinforced resin in which continuous fibers are hardened with a resin, and the first and second ribs are formed from a discontinuous fiber-reinforced resin in which discontinuous fibers are hardened with a resin.

Further, according to an eleventh aspect of the present invention, in addition to the ninth or tenth aspect, the first and second ribs are provided as pluralities along a vehicle body fore-and-aft direction.

Furthermore, according to a twelfth aspect of the present invention, in addition to any one of the ninth to eleventh aspects, the position in the vehicle body fore-and-aft direction of an X-shaped intersection point of the first rib coincides with the position in the vehicle body fore-and-aft direction of an X-shaped intersection point of the second rib.

Moreover, according to a thirteenth aspect of the present invention, in addition to any one of the ninth to twelfth aspects, front ends of the first and second ribs are positioned to the rear of the front end of the bumper beam extension by a predetermined distance.

Further, according to a fourteenth aspect of the present invention, in addition to any one of the ninth to thirteenth aspects, the second side wall has a draft angle in the vehicle width direction for removal from a mold.

Furthermore, according to a fifteenth aspect of the present invention, in addition to the first aspect, the lower member comprises a first portion extending downwardly toward the front from the front end of the upper member, a second portion bending via a first bent portion at a front end of the first portion and extending forwardly in a horizontal direction, and a third portion bending toward the inner side in the vehicle width direction via a second bent portion at a front end of the second portion and connected to the front end of the bumper beam extension, the lower member comprises a main body part having a squared U-shaped cross section opening outwardly in the vehicle width direction while comprising a bottom wall and a pair of side walls, and comprises a plurality of ribs connecting the bottom wall and the pair of side walls, the bottom wall is formed from a continuous fiber-reinforced resin in which continuous fibers are hardened with a resin, and the pair of side walls and the ribs are formed from a discontinuous fiber-reinforced resin in which discontinuous fibers are hardened with a resin.

Moreover, according to a sixteenth aspect of the present invention, in addition to the fifteenth aspect, the ribs are formed into a lattice shape with a horizontal rib extending along a longitudinal direction of the lower member and a plurality of vertical ribs intersecting the horizontal rib.

Further, according to a seventeenth aspect of the present invention, in addition to the sixteenth aspect, one of the vertical ribs is disposed in the first bent portion.

Furthermore, according to an eighteenth aspect of the present invention, in addition to the sixteenth aspect, the horizontal rib is connected to the bottom wall and extends rearwardly from the front end of the lower member.

Moreover, according to a nineteenth aspect of the present invention, in addition to any one of the fifteenth to eighteenth aspects, the lower member comprises a flange at the front end for connection to the front end of the bumper beam extension, and the flange is formed from a discontinuous fiber-reinforced resin in which discontinuous fibers are hardened with a resin.

A front side frame base part 23 and a front side frame extremity part 24 of an embodiment correspond to the front side frame of the present invention, a first bottom wall 31d, a second reinforcing flange 31g, and a first linking portion 31j of the embodiment correspond to the bumper beam support part of the present invention, a first reinforcing flange 31f, a fourth linking portion 31n, and a fifth linking portion 31o of the embodiment correspond to the lower member support part of the present invention, a first rib 32, a second rib 33, a horizontal rib 38, a vertical rib 39, a horizontal rib 41, and a vertical rib 42 of the embodiment correspond to the rib of the present invention, a second mounting flange 34g of the embodiment corresponds to the flange of the present invention, and a first side wall 36 and a second side wall 37 of the embodiment correspond to the side wall of the present invention.

### Effects of the Invention

In accordance with the first aspect of the present invention, since the bumper beam, which is made of a fiber-reinforced resin and extends in the vehicle width direction, and the pair of left and right lower members, which are made of a fiber-reinforced resin and extend downwardly toward the front, forwardly, and inwardly in the vehicle width direction while bending from the front ends of the pair of left and right upper members, are connected to the front ends of the pair of left and right bumper beam extensions, which are made of a fiber-reinforced resin and extend from the front ends of the pair of left and right front side frames toward the front of the vehicle body, and the front faces and the outer faces in the vehicle width direction of the pair of left and right lower members and the front face of the bumper beam are curved into a U-shape pointing toward the front of the vehicle body when viewed from above, not only is it possible to reduce the weight of the vehicle body frame in the front part of the motor vehicle, but it is also possible to transmit to the bumper beam extensions a collision load inputted even into the bumper beam or inputted even into the front parts of the lower members, thus absorbing the collision load and, moreover, since the bumper beam does not protrude from the lower members toward the front of the vehicle body, it is possible to reduce the dimensions of the vehicle body front part.

Furthermore, in accordance with the second aspect of the present invention, since the bumper beam is connected to inner walls in the vehicle width direction at the front ends of the pair of left and right bumper beam extensions, the pair of left and right lower members are connected to outer walls in the vehicle width direction at the front ends of the pair of left and right bumper beam extensions, and the front faces and the outer faces in the vehicle width direction of the pair of left and right lower members, the front end faces of the pair of left and right bumper beam extensions, and the front face of the bumper beam are curved into a U-shape pointing toward the front of the vehicle body when viewed from above, not only is it possible to reduce the weight of the vehicle body frame in the front part of the motor vehicle, it is also possible to transmit to the bumper beam extensions a collision load inputted even into the bumper beam or inputted even into the front parts of the lower members, thus absorbing the collision load and, moreover, since the bumper beam does not protrude from the lower members toward the front of the vehicle body, it is possible to reduce the dimensions of the vehicle body front part.

Moreover, in accordance with the third aspect of the present invention, since the bumper beam support part for supporting the inner end in the vehicle width direction of the bumper beam is provided on the inner face in the vehicle width direction of the front end part of the bumper beam extension, it is possible to transmit from the bumper beam support part to the bumper beam extension a collision load inputted into the bumper beam when there is a frontal collision to thus efficiently absorb it and, furthermore, since the lower member support part for supporting the front end, bending inwardly in the vehicle width direction, of the lower member is provided on the outer face in the vehicle width direction of the front end part of the bumper beam extension, it is possible to transmit from the lower member support part to the bumper beam extension a collision load inputted into the front part of the lower member when there is a narrow offset frontal collision to thus efficiently absorb it.

Moreover, in accordance with the fourth aspect of the present invention, since the front end part of the bumper beam extension includes the weak part, it is possible for the weak part to crumple at the initial stage of a collision, thus reducing the peak load.

Furthermore, in accordance with the fifth aspect of the present invention, since the bumper beam, the lower member, and the bumper beam extension include the main body part formed by hardening the continuous fibers with a resin so as to have an open cross section, and the ribs that are formed by hardening the discontinuous fibers with a resin and that provide a connection between the inner faces of the main body part, it is possible to achieve a balance between strength and moldability by reinforcing the main body part having a relatively simple shape with the continuous fibers having high strength and reinforcing the main body part having a relatively complicated shape with the discontinuous fibers having high moldability. As a result, opening of the jaws of the main body part having an open cross section can be prevented by means of the ribs, thereby giving high strength with a lightweight structure.

Moreover, in accordance with the sixth aspect of the present invention, since the bumper beam and the lower member have the plurality of vertical ribs in the interior of the main body part having a squared U-shaped cross section, the strength against twisting or bending of the main body part can be enhanced by means of the ribs and collision energy can be efficiently absorbed by the main body part and the ribs being sequentially crumpled from the end side by the collision load.

Furthermore, in accordance with the seventh aspect of the present invention, since the bumper beam extension has the plurality of X-shaped ribs in the interior of the main body part having an S-shaped cross section, the strength against twisting or bending of the main body part can be enhanced by means of the ribs, and collision energy can be efficiently absorbed by the main body part and the rib being sequentially crumpled from the end side by the collision load.

Moreover, in accordance with the eighth aspect of the present invention, since the width in the vertical direction of the bumper beam is larger for the middle part in the vehicle width direction than for the end parts in the vehicle width direction, even if the height of the bumper beam and the height of a member that is collided with are different, the probability of the collision load being able to be received by means of the bumper beam to thus absorb the impact increases.

Furthermore, in accordance with the ninth aspect of the present invention, since the main body part of the bumper beam extension includes the first side wall, the first bottom wall, the second side wall, the second bottom wall, and the third side wall and is formed so as to have an S-shaped cross section, the first side wall, the first bottom wall, and the second side wall are connected via the first rib forming an X-shape when viewed in the vehicle width direction, and the third side wall, the second bottom wall, and the second side wall are connected via the second rib forming an X-shape when viewed in the vehicle width direction, when a collision load is inputted into the bumper beam extension in its longitudinal direction, the first and second ribs can prevent the jaws of the opening part of the bumper beam extension, which has an open cross section, from opening, and the main body part and the first and second ribs of the bumper beam extension are compressed in the longitudinal direction and buckle to thus absorb collision energy effectively. Moreover, since the bumper beam extension has an open cross section, not only is it light in weight, but it is also easy to carry out molding using a mold.

Furthermore, in accordance with the tenth aspect of the present invention, since the main body part of the bumper beam extension is formed from a continuous fiber-reinforced resin in which continuous fibers are hardened with a resin, the strength of the main body part can be enhanced by means of the continuous fibers and, moreover, since the first and second ribs are formed from a discontinuous fiber-reinforced resin in which discontinuous fibers are hardened with a resin, the ribs having a complicated shape can be molded using a fiber-reinforced resin member, thereby enabling a balance between strength and moldability of the bumper beam extension to be achieved.

Furthermore, in accordance with the eleventh aspect of the present invention, since the pluralities of first and second ribs are provided along the vehicle body fore-and-aft direction, it is possible to absorb collision energy with a stable load over a long period from the initial time of collision to the final time of collision while holding down the peak load to a low level.

Moreover, in accordance with the twelfth aspect of the present invention, since the position in the vehicle body fore-and-aft direction of the X-shaped intersection point of the first rib is made to coincide with the position in the vehicle body fore-and-aft direction of the X-shaped intersection point of the second rib, it is possible to crumple the bumper beam extension stepwise from the extremity side while more reliably preventing open of the jaws of the main body part of the bumper beam extension by means of the first and second ribs.

Furthermore, in accordance with the thirteenth aspect of the present invention, since the front ends of the first and second ribs are positioned to the rear of the front end of the bumper beam extension by a predetermined distance, it is possible to easily crumple the front end part of the bumper beam extension, in which the first and second ribs are not formed, at the initial stage of a frontal collision, thus reducing the peak load at the initial stage of collision.

Moreover, in accordance with the fourteenth aspect of the present invention, since the second side wall of the main body part of the bumper beam extension has a draft angle in the vehicle width direction, the bumper beam extension can easily be removed from the mold.

Furthermore, in accordance with the fifteenth aspect of the present invention, since the lower member includes the first portion extending downwardly toward the front from the front end of the upper member, the second portion bending via the first bent portion at the front end of the first portion and extending forwardly in the horizontal direction, and the third portion bending inwardly in the vehicle width direction via the second bent portion at the front end of the second portion and connected to the front end of the bumper beam extension, when there is a narrow offset frontal collision, if a collision load in the fore-and-aft direction is inputted into the front end of the lower member, there is a possibility that the lower member would fold back via the first and second bent portions and the collision load would not be able to be absorbed effectively. However, since the lower member includes the main body part having a squared U-shaped draft section opening outwardly in the vehicle width direction while having the bottom wall and the pair of side walls, and the plurality of ribs providing a connection between the bottom wall and the pair of side walls, the bottom wall is formed from a continuous fiber-reinforced resin in which the continuous fibers are hardened with a resin, and the pair of side wall parts and the ribs are formed from a discontinuous fiber-reinforced resin in which the discontinuous fibers are hardened with a resin, even if the collision load acts so as to fold back the first bent portion, which is bent in the vertical direction, the continuous fiber-reinforced resin of the bottom wall provides resistance thereto, and the side wall parts also provide resistance thereto, thus preventing the first bent portion from breaking and, moreover, even if the collision load acts so as to fold back the second bent portion, which is bent in the left and right direction, the side wall parts and the rib provide resistance thereto, thus preventing the second bent portion from breaking. This enables the lower member to be sequentially crumpled from the front side toward the rear side by means of the load of a frontal collision, thus absorbing the collision load effectively. Moreover, since the bottom wall of the lower member curves only in the second bent portion, the lower member can be press formed using a mold.

Moreover, in accordance with the sixteenth aspect of the present invention, since the rib of the lower member is formed in a lattice shape so as to have the horizontal rib extending along the longitudinal direction of the lower member and the plurality of vertical ribs intersecting the horizontal rib, it is possible to reinforce effectively the main body part of the lower member while lightening the weight by reducing the thickness of the rib, thereby enabling the main body part and the rib to be crumpled by a collision load and thus absorb the collision energy.

Furthermore, in accordance with the seventeenth aspect of the present invention, since one of the plurality of vertical ribs is disposed in the first bent portion for reinforcement, when a large bending moment is applied to the first bent portion due to the load of an offset frontal collision, it is possible to prevent the lower member from breaking via the first bent portion, thus ensuring the impact absorption performance.

Moreover, in accordance with the eighteenth aspect of the present invention, since the horizontal rib is connected to the bottom wall and extends rearwardly from the front end of the lower member, due to the high strength bottom wall, which is reinforced with the continuous fibers, being further reinforced with the horizontal rib, when the load of an offset frontal collision is inputted into the front end of the lower member, it is possible to prevent the lower member from breaking via the first bent portion or the second bent portion, thus ensuring the impact absorption performance.

Furthermore, in accordance with the nineteenth aspect of the present invention, since the flange is provided at the front end of the lower member, the front end of the lower member can easily be connected to the front end of the bumper beam extension. Moreover, since the flange is formed from a discontinuous fiber-reinforced resin in which the discontinuous fibers are hardened with a resin, the main body part and the flange of the lower member can be molded all at once, thus enabling the number of processing steps to be cut.

### BRIEF DESCRIPTION OF DRAWINGS

FIG. 1 is a perspective view of the framework of a motor vehicle containing a fiber-reinforced resin as a main body. (first embodiment)

FIG. 2 is an enlarged view of part 2 in FIG. 1. (first embodiment)

FIG. 3 is a view in the direction of arrow 3 in FIG. 2. (first embodiment)

FIG. 4 shows perspective views of a bumper beam extension. (first embodiment)

FIG. 5 shows perspective views of a lower member. (first embodiment)

FIG. 6 is a perspective view of a bumper beam. (first embodiment)

FIG. 7 shows sectional views along lines 7(A)-7(A), 7(B)-7(B), and 7(C)-7(C) in FIG. 2. (first embodiment)

FIG. 8 shows enlarged views from the direction of arrow 8(A) and the direction of arrow 8(B) in FIG. 7. (first embodiment)

FIG. 9 shows diagrams for explaining the structure and operation of a mold. (first embodiment)

FIG. 10 is a diagram for explaining the operation when the motor vehicle is involved in a frontal collision. (first embodiment)

FIG. 11 shows diagrams for explaining the operation of absorbing an impact by means of the bumper beam extension. (first embodiment)

### EXPLANATION OF REFERENCE NUMERALS AND SYMBOLS

11 Cabin
16 Front wall part
16a Wheel house
22 Upper member
23 Front side frame base part (front side frame)
24 Front side frame extremity part (front side frame)
25 Bumper beam extension
27 Lower member
29 Bumper beam
31 Main body part
31a First side wall
31b Second side wall
31c Third side wall
31d First bottom wall (bumper beam support portion)
31e Second bottom wall
31f First reinforcing flange (lower member support portion)
31g Second reinforcing flange (bumper beam support portion)
31j First linking portion (bumper beam support portion)
31n Fourth linking portion (lower member support portion)
31o Fifth linking portion (lower member support portion)
31p Weak portion
32 First rib (rib)
33 Second rib (rib)
34 Main body part
34a First portion
34b Second portion
34c Third portion
34d First bent portion
34e Second bent portion
34g Second mounting flange (flange)
35 Bottom wall
36 First side wall (side wall)
37 Second side wall (side wall)
38 Horizontal rib (rib)
39 Vertical rib (rib)
40 Main body part
41 Horizontal rib (rib)
42 Vertical rib (rib)
44A Continuous fiber
44B Continuous fiber
45 Discontinuous fiber
46 Mold

### MODE FOR CARRYING OUT THE INVENTION

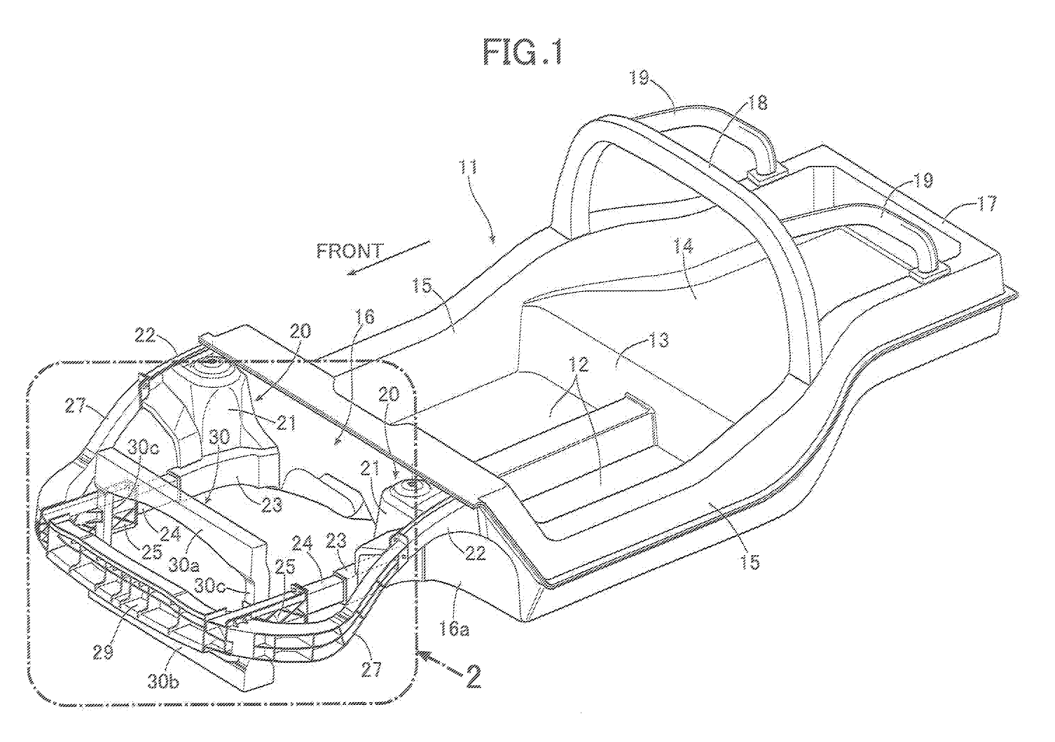

A mode for carrying out the present invention is explained below by reference to FIG. 1 to FIG. 11.

### First Embodiment

As shown in FIG. 1 to FIG. 3, a cabin 11 made of carbon fiber-reinforced resin (CFRP) is formed into a bathtub shape while including a front floor panel 12, a rear floor panel 14 connected to the rear end of the front floor panel 12 via a kick-up part 13, left and right side sill parts 15 and 15 extending in the fore-and-aft direction along opposite edges in the vehicle width direction of the front floor panel 12 and the rear floor panel 14, a front wall part 16 rising from front ends of the front floor panel 12 and the left and right side sill parts 15 and 15, and a rear wall part 17 rising from rear ends of the rear floor panel 14 and the left and right side sill parts 15 and 15. Fixed to upper faces of the left and right side sill parts 15 and 15 are an inverted U-shaped roll bar 18 and left and right stays 19 and 19 reinforcing the roll bar 18.

Metal linking modules 20 and 20 are secured to opposite end parts in the vehicle width direction on a front face of the front wall part 16 of the cabin 11 by means of bolts, which are not illustrated. In each linking module 20, a damper housing 21, an upper member 22, and a front side frame base part 23 are formed as a unit, and the rear end of a metal front side frame extremity part 24, which is a separate member, is linked in series to the front end of the front side frame base part 23. The upper member 22 is a member disposed above a wheel house 16a (see FIG. 1) formed in the front wall part 16 of the cabin 11.

Rear ends of left and right bumper beam extensions 25 and 25 made of a CFRP are secured to front ends of the left and right front side frame extremity parts 24 and 24 by means of bolts 26, and rear ends of left and right lower members 27 and 27 made of a CFRP by means of bolts 28 are secured to front ends of the upper members 22 and 22 of the left and right linking modules 20 and 20. Opposite end parts in the vehicle width direction of a bumper beam 29 made of a CFRP are connected to inner faces in the vehicle width direction of front ends of the left and right bumper beam extensions 25 and 25, and inner faces in the vehicle width direction of front ends of the left and right lower members 27 and 27 are connected to outer faces in the vehicle width direction of the front ends of the left and right bumper beam extensions 25 and 25. A front bulkhead 30 is connected to inner faces in the vehicle width direction of the left and right bumper beam extensions 25 and 25, the front bulkhead 30 being formed into a rectangular frame shape by joining an upper member 30a, a lower member 30b, and left and right side members 30c and 30c made of a CFRP.

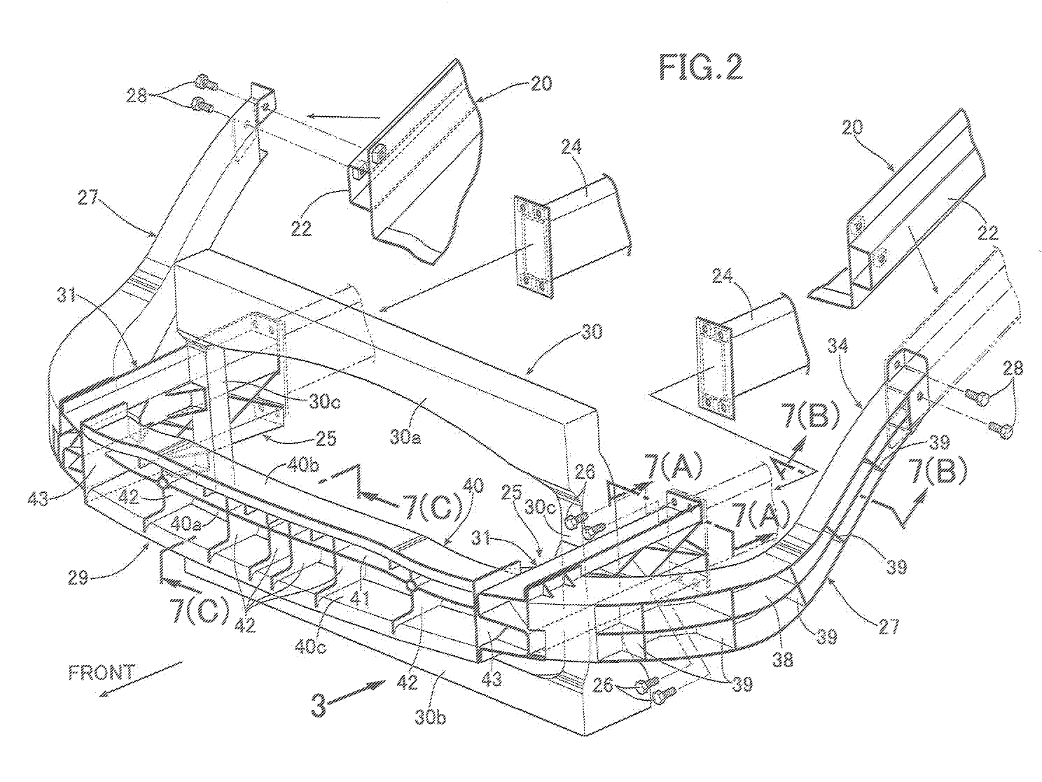

The structures of the bumper beam extensions 25 and 25 are now explained by reference to FIG. 2 to FIG. 4. Since the left and right bumper beam extensions 25 and 25 are mirror symmetric members, the structure of the left bumper beam extension 25 is explained as being representative thereof.

The bumper beam extension 25, which is made of a CFRP, is a member comprising a main body part 31 extending linearly in the fore-and-aft direction, the main body part 31 being formed so as to have an S-shaped cross section while comprising an upper first side wall 31a, a middle second side wall 31b, and a lower third side wall 31c, which are disposed substantially parallel to each other, a first bottom wall 31d providing a connection between inner ends in the vehicle width direction of the first side wall 31a and the second side wall 31b, and a second bottom wall 31e providing a connection between outer ends in the vehicle width direction of the third side wall 31c and the second side wall 31b. A first reinforcing flange 31f protrudes upwardly from the outer end in the vehicle width direction of the first side wall 31a, and a second reinforcing flange 31g protrudes downwardly from the inner end in the vehicle width direction of the third side wall 31c. A first mounting flange 31h, which is fixed to the front end of the front side frame extremity part 24 by means of the bolts 26 and 26, protrudes upwardly from the rear end of the first side wall 31a, and a second mounting flange 31i, which is fixed to the front end of the front side frame extremity part 24 by means of the bolts 26 and 26, protrudes downwardly from the rear end of the third side wall 31c.

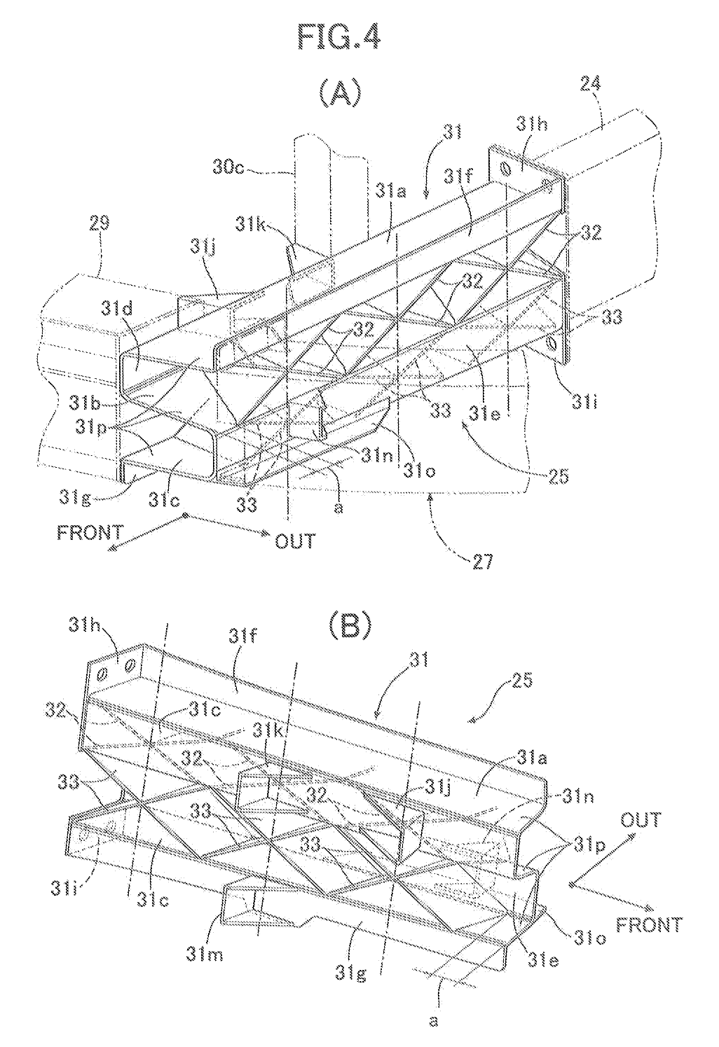

Furthermore, a first linking portion 31j and a second linking portion 31k, which are triangular, are projectingly provided on an inner face in the vehicle width direction of the first bottom wall 31d, a triangular third linking portion 31m is projectingly provided on an inner face in the vehicle width direction of the second reinforcing flange 31g, a triangular fourth linking portion 31n is projectingly provided on an outer face in the vehicle width direction of the second bottom wall 31e, and a plate-shaped fifth linking portion 31o is provided so as to project outwardly in the vehicle width direction from the lower end of the second bottom wall 31e. The first side wall 31a and the third side wall 31c extend horizontally when viewed from the front, and the second side wall 31b has a draft angle that is inclined relative to the horizontal direction in order to facilitate removal from a mold (see FIG. 4).

Three first ribs 32 formed into an X-shape are formed in succession in the fore-and-aft direction in a space that is surrounded by the first side wall 31a, the first bottom wall 31d, and the second side wall 31b and that opens outwardly in the vehicle width direction. Similarly, three second ribs 33 formed into an X-shape are formed in succession in the fore-and-aft direction in a space that is surrounded by the third side wall 31c, the second bottom wall 31e, and the second side wall 31b and that opens inwardly in the vehicle width direction. The positions of three intersection points of the X-shaped first ribs 32 and the positions of three intersection points of the X-shaped second ribs 33 are aligned in the vehicle body fore-and-aft direction. In other words, the three intersection points of the second ribs 33 on the lower side are positioned beneath the three intersection points of the first ribs 32 on the upper side (see FIG. 4). Furthermore, front ends of the first ribs 32 and the second ribs 33 are positioned to the rear of the front end of the main body part 31 with a weak portion 31p having a length a interposed between the front end of the main body part 31 and the front ends of the first and second ribs 32 and 33 (see FIG. 4).

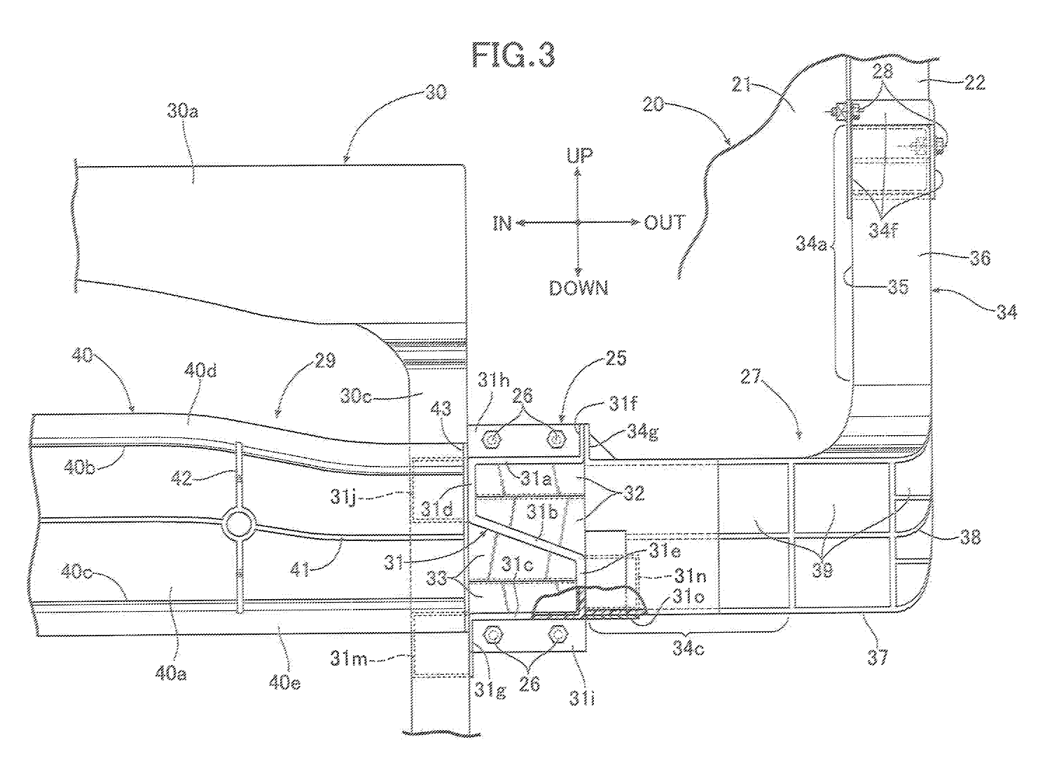

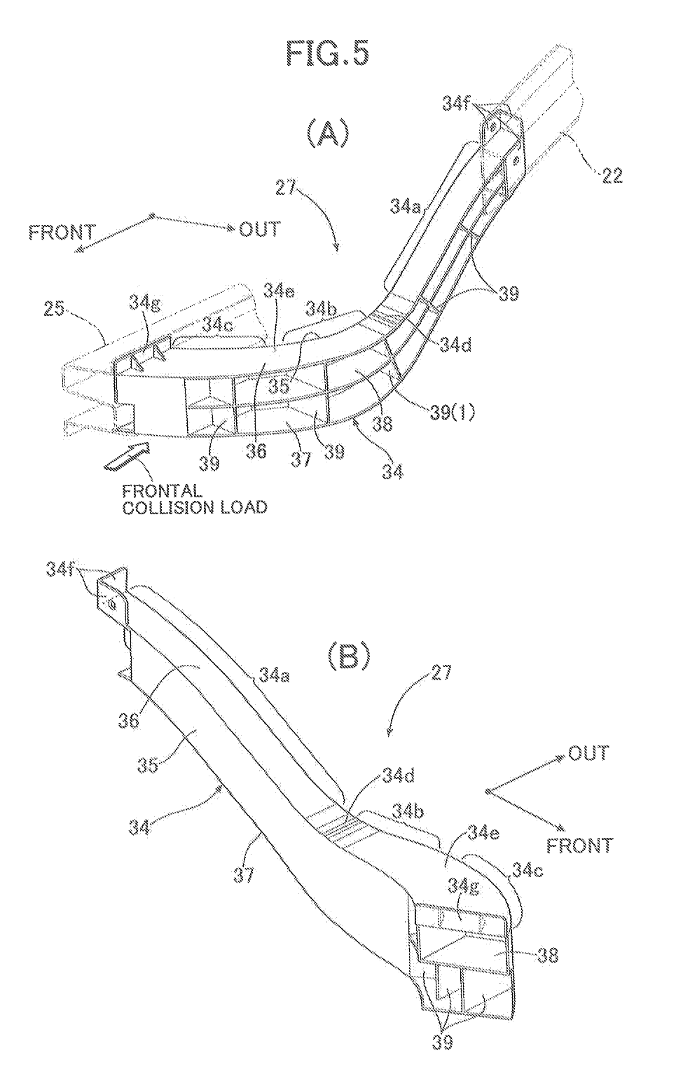

The structures of the lower members 27 and 27 are now explained by reference to FIG. 2, FIG. 3, and FIG. 5. Since the left and right lower members 27 and 27 are mirror symmetric members, the structure of the left lower member 27 is explained as being representative thereof.

A main body part 34 of the lower member 27, which is made of a CFRP, includes a first portion 34a extending downwardly toward the front from the front end of the upper member 22, a second portion 34b bending upwardly from the front end of the first portion 34a via a first bent portion 34d and extending substantially horizontally and forwardly, and a third portion 34c bending inwardly in the vehicle width direction from the front end of the second portion 34b via a second bent portion 34e and extending substantially horizontally and inwardly in the vehicle width direction. The main body part 34 is formed so as to have a squared U-shaped cross section while including a bottom wall 35 forming an inner face in the vehicle width direction and a rear face, a first side wall 36 extending from the upper edge of the bottom wall 35 outwardly in the vehicle width direction and forwardly, and a second side wall 37 extending from the lower edge of the bottom wall 35 outwardly in the vehicle width direction and forwardly.

First mounting flanges 34f joined to the front end of the upper member 22 by means of the bolts 28 are provided at the rear end of the first portion 34a, and a second mounting flange 34g connected to the bumper beam extension 25 is provided at the inner end in the vehicle width direction of the third portion 34c.

Formed in a lattice shape in the interior of the main body part 34 are one horizontal rib 38 that protrudes from the bottom wall 35 in parallel with the first and second side walls 36 and 37 so as to extend outwardly in the vehicle width direction and forwardly and a plurality of vertical ribs 39 intersecting the horizontal rib 38 and connected to the bottom wall 35 and the first and second side walls 36 and 37. Among the plurality of vertical ribs 39, one 39 (1) is disposed at the position of the first bent portion 34d of the lower member 27 (see FIG. 5 (A)).

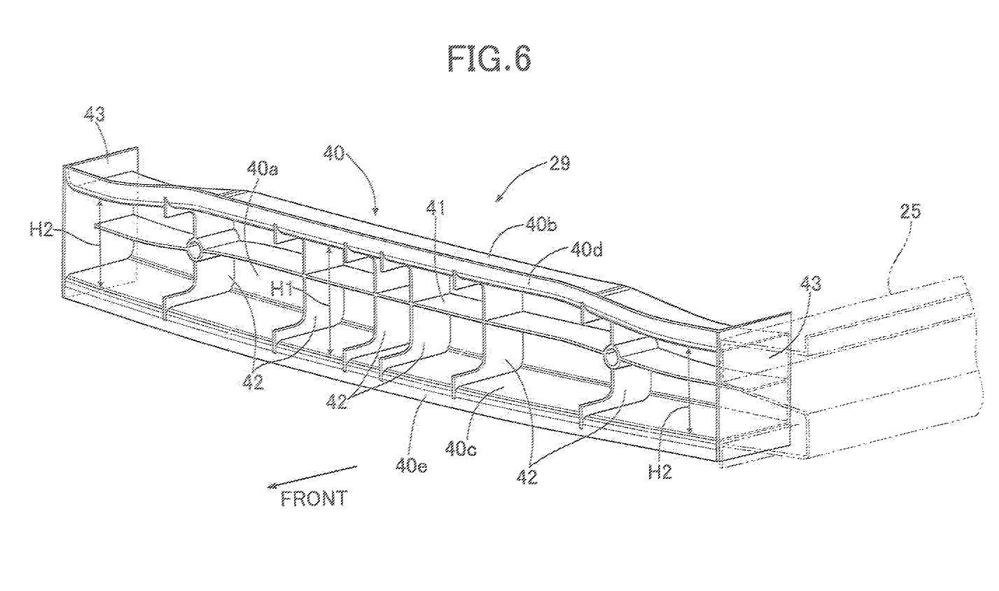

The structure of the bumper beam 29 is now explained by reference to FIG. 2, FIG. 3, and FIG. 6.

A main body part 40 of the bumper beam 29 is a member having a squared U-shaped cross section with an open front face and including a bottom wall 40a and upper and lower side walls 40b and 40c, and flanges 40d and 40e protrude in the vertical direction from the front edges of the upper and lower side walls 40b and 40c. Formed in a lattice shape on an inner face of the main body part 40 are one horizontal rib 41 extending in the vehicle width direction and a plurality of vertical ribs 42 extending in the vertical direction so as to be perpendicular to the horizontal rib 41, the rear edge of the horizontal rib 41 being connected to the bottom wall 40a, and the rear edges and the upper and lower edges of the vertical ribs 42 being connected to the bottom wall 40a and the side walls 40b and 40c. A pair of left and right plate-shaped end brackets 43 and 43 made of a fiber-reinforced resin are provided at opposite ends in the vehicle width direction of the main body part 40.

The distance between the upper and lower side walls 40b and 40c of the bumper beam 29 is H1 for a middle part in the vehicle width direction of the bumper beam 29 and H2 for opposite end parts in the vehicle width direction, H2 being smaller than H1. That is, the width in the vertical direction of the bumper beam 29 is larger for an intermediate part in the vehicle width direction than in the opposite end parts in the vehicle width direction (see FIG. 6). Therefore, even when the height of the bumper beam 29 is different from the height of a member that is collided with, the collision load can be received by the bumper beam 29, thus increasing the probability of the impact being able to be absorbed.

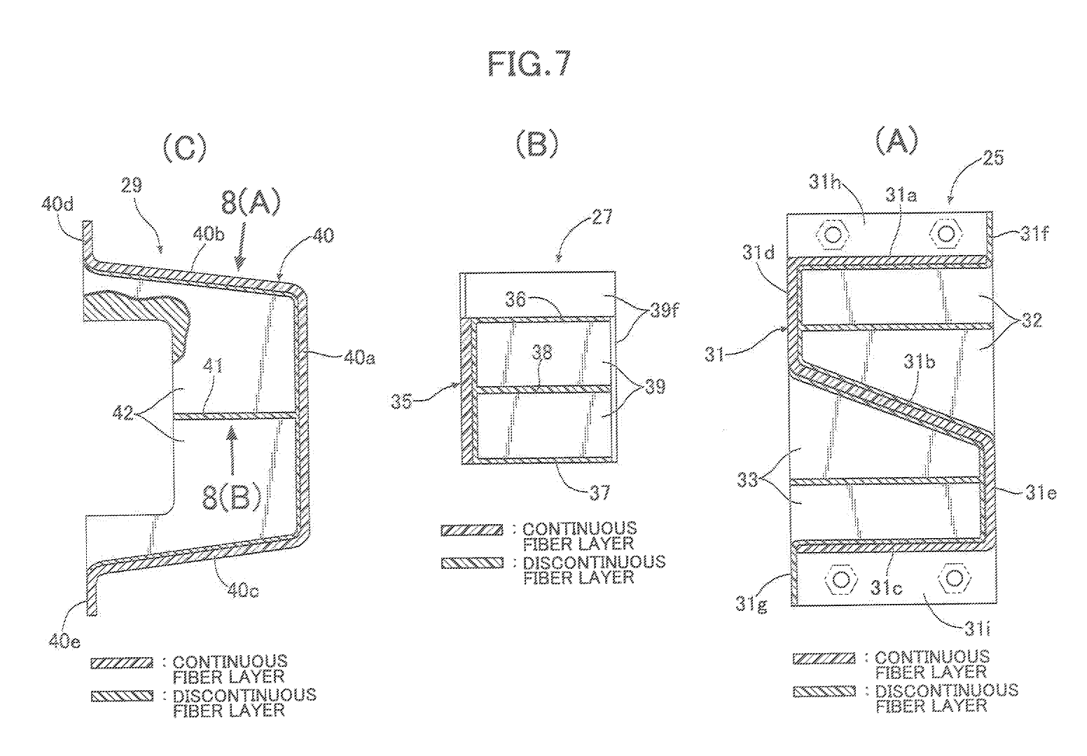

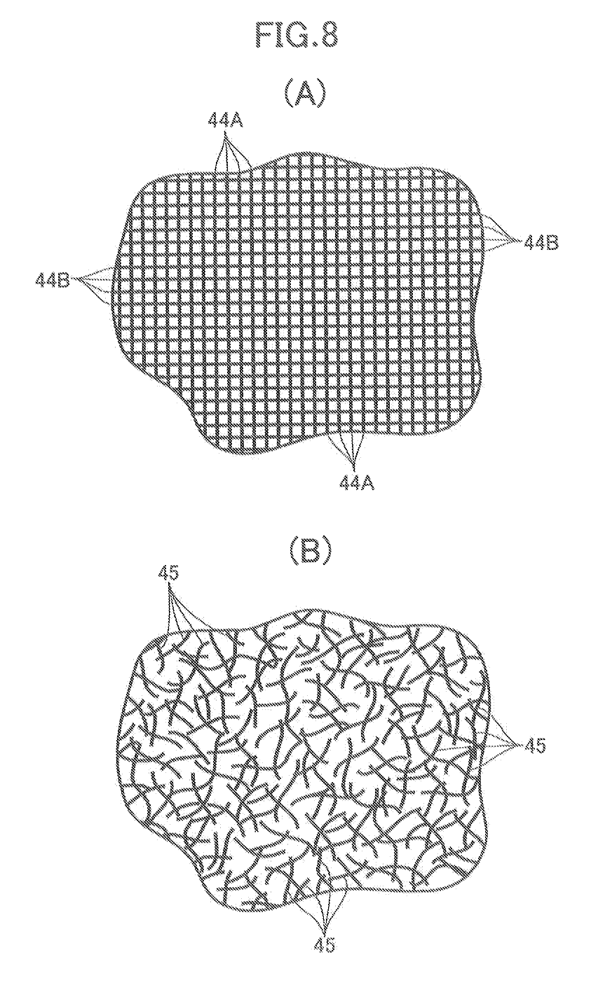

As shown in FIG. 7 (A), the first side wall 31a, the second side wall 31b, the third side wall 31c, the first bottom wall 31d, and the second bottom wall 31e of the main body part 31 of the bumper beam extension 25 are formed from a material formed by hardening, with a resin, a woven cloth formed by plain weaving continuous fibers 44A, 44B made of carbon fiber (see FIG. 8 (A)), and other parts including the first ribs 32 and the second ribs 33 are formed from a material formed by hardening, with a resin, randomly tangled discontinuous fibers 45 made of carbon fiber (see FIG. 8 (B)). Furthermore, inner faces of the first side wall 31a, the second side wall 31b, and the first bottom wall 31d and inner faces of the third side wall 31c, the second side wall 31b, and the second bottom wall 31e are covered with a thin film formed by hardening, with a resin, discontinuous fibers 45 made of carbon fiber.

As shown in FIG. 7 (B), the bottom wall 35 of the main body part 34 of the lower member 27 is formed from a material formed by hardening, with a resin, a woven cloth formed by plain weaving continuous fibers 44A, 44B made of carbon fiber, but other parts such as the first side wall 36, the second side wall 37, the horizontal rib 38, and the vertical ribs 39 are formed from a material formed by hardening, with a resin, randomly tangled discontinuous fibers 45 made of carbon fiber. Furthermore, an inner face of the bottom wall 35 is covered with a thin film formed by hardening, with a resin, discontinuous fibers 45 made of carbon fiber.

As shown in FIG. 7 (C), the bottom wall 40a, the upper and lower side walls 40b and 40c, and the upper and lower flanges 40d and 40e of the main body part 40 of the bumper beam 29 are formed from a material formed by hardening, with a resin, a woven cloth formed by plain weaving continuous fibers 44A, 44B made of carbon fiber, but other parts such as the horizontal rib 41, the vertical ribs 42, and the end brackets 43 and 43 are formed from a material formed by hardening, with a resin, randomly tangled discontinuous fibers 45 made of carbon fiber. Furthermore, an inner face of the main body part 40 is covered with a thin film formed by hardening, with a resin, discontinuous fibers 45 made of carbon fiber.

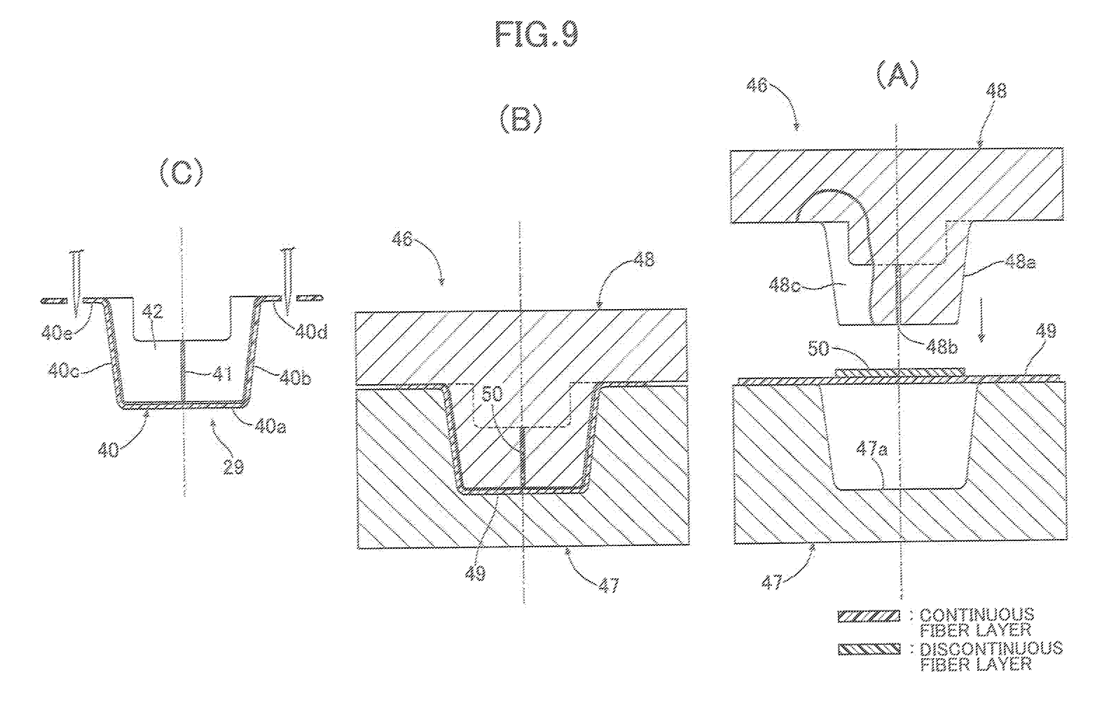

The structure of a mold 46 for press forming the bumper beam 29 is now explained by reference to FIG. 9.

As shown in FIG. 9 (A), a mold 46 for press forming the bumper beam 29 includes a female die 47 having a recessed cavity 47a for molding an outer surface of the main body part 40 and a male die 48 having a projecting core 48a for molding an inner surface of the main body part 40, and a horizontal groove 48b for molding the horizontal rib 41 and vertical grooves 48c for molding the vertical ribs 42 are formed in the core 48a. In a state in which the mold 46 is opened, a first prepreg 49 of continuous fibers and a second prepreg 50 of discontinuous fibers are disposed in an upper part of the cavity 47a of the female die 47 in a preheated state. In the present embodiment, the length of the discontinuous fibers of the second prepreg 50 is set at 0.9 mm to 4.4 mm.

The prepreg is formed by impregnating a woven cloth or UD (sheet in which continuous fibers are aligned in one direction) formed from a continuous fiber such as carbon fiber, glass fiber, or aramid fiber or a mat of discontinuous fibers as a reinforcing material with a semi-cured thermosetting resin (epoxy resin, polyester resin, etc.) or a thermoplastic resin (nylon 6, polypropylene, etc.), and it has the flexibility to conform to the shape of the mold. In the case of a thermosetting resin, a plurality of sheets of prepreg are layered, inserted into the mold, and heated to for example on the order of 130° C. while applying pressure, and the thermosetting resin cures to thus give a fiber-reinforced resin product. In the case of a thermoplastic resin, a plurality of sheets of pre-heated prepreg are layered, inserted into the mold, molded under pressure, and then cooled, thus giving a fiber-reinforced resin product.

Subsequently, as shown in FIG. 9 (B), the male die 48 is lowered relative to the female die 47, and the first prepreg 49 is pressed by means of the cavity 47a of the female die 47 and the core 48a of the male die 48, thus molding the main body part 40 of the bumper beam 29 having a squared U-shaped cross section. In this process, since the second prepreg 50 containing discontinuous fibers as a reinforcing material is easily deformable, the second prepreg 50 sandwiched between the first prepreg 49 and the core 48a of the male die 48 flows into the horizontal groove 48b and vertical grooves 48c of the core 48a, thus molding the horizontal rib 41, the vertical ribs 42, and the end brackets 43 and 43 of the bumper beam 29 at the same time. Furthermore, part of the second prepreg 50 is layered as a thin film along the inner surface of the main body part 40.

Subsequently, as shown in FIG. 9 (C), the bumper beam 29 is completed by cutting off an excess part of the flanges 40d and 40e of the main body part 40 of the bumper beam 29 that has been taken out of the mold 46.

As described above, since the fiber-reinforced resin for the main body part 40 of the bumper beam 29 having a simple squared U-shaped cross section is reinforced with plain-woven continuous fibers 44A, 44B having a high strength, and the fiber-reinforced resin for the horizontal rib 41, the vertical ribs 42, and the end brackets 43 and 43, which have complicated shapes and are difficult to reinforce with plain-woven continuous fibers, is reinforced with the discontinuous fibers 45 having a high degree of freedom of molding, it is possible to achieve a balance between strength and moldability of the bumper beam 29. Moreover, since the first prepreg 49 containing continuous fibers and the second prepreg 50 containing discontinuous fibers are placed within one and the same mold 46 to thus mold the bumper beam 29 in one step, compared with a case in which they are molded separately and integrated by adhesion or melt bonding, it is possible to cut the production cost.

The mold 46 for press forming the bumper beam 29 is explained above, but the bumper beam extensions 25 and 25 and the lower members 27 and 27 may also be press formed using a mold having a similar structure. In this way, since the bumper beam 16, the bumper beam extensions 25 and 25, and the lower members 27 and 27 all have an open cross section, not only are they light in weight, but it is also easy to carry out molding using the mold.

The structure via which the bumper beam 29 and the lower member 27 are joined to the bumper beam extension 25 is now explained.

As shown in FIG. 2 to FIG. 5, the outer end in the vehicle width direction of the bumper beam 29 extending in the vehicle width direction is joined to an inner face in the vehicle width direction at the front end of the bumper beam extension 25 extending in the fore-and-aft direction. In this arrangement, the front part of the first bottom wall 31d of the main body part 31 and the front part of the second reinforcing flange 31g of the bumper beam extension 25 are melt bonded to the end bracket 43 of the bumper beam 29, and the first linking portion 31j provided on the first bottom wall 31d of the bumper beam extension 25 is melt bonded to the bottom wall 40a of the main body part 40 of the bumper beam 29. The first bottom wall 31d, the second reinforcing flange 31g, and the first linking portion 31j of the bumper beam extension 25 form a bumper beam support part.

Furthermore, the second mounting flange 34g at the extremity of the lower member 27 is melt bonded to the first reinforcing flange 31f of the bumper beam extension 25, a lower face of an extremity part of the second side wall 37 of the lower member 27 is melt bonded to an upper face of the fifth linking portion 31o protruding from the second bottom wall 31e of the bumper beam extension 25, and an extremity part of the bottom wall 35 of the lower member 27 is melt bonded to the fourth linking portion 31n provided on the second bottom wall 31e of the bumper beam extension 25. The first reinforcing flange 31f, the fifth linking portion 31o, and the fourth linking portion 31n of the bumper beam extension 25 form a lower member support part.

The side member 30c of the front bulkhead 30 is melt bonded to the second linking portion 31k and the third linking portion 31m of the main body part 31 of the lower member 27.

The operation of the embodiment of the present invention having the above arrangement is now explained.

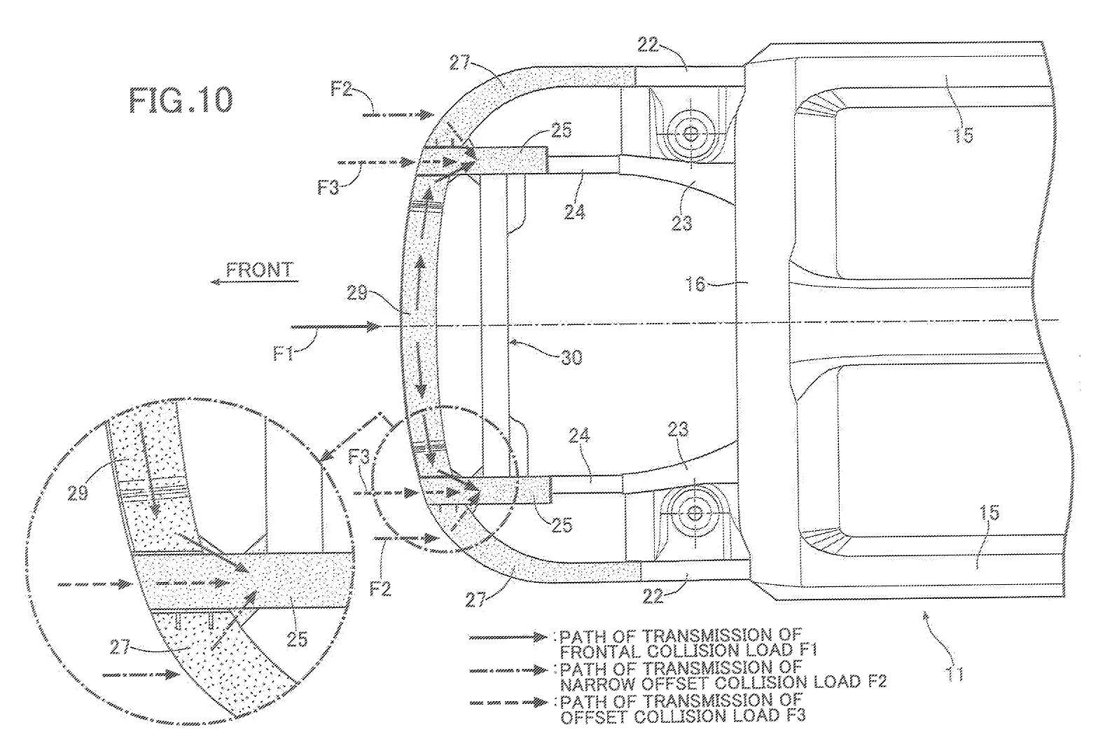

As shown in FIG. 10, since the bumper beam 29, which is made of a CFRP and extends in the vehicle width direction, and the pair of left and right lower members 27 and 27, which are made of a CFRP and extend from the front ends of the pair of left and right upper members 22 and 22 downwardly toward the front, forwardly, and inwardly in the vehicle width direction while bending, are connected to the inner faces in the vehicle width direction and the outer faces in the vehicle width direction of the front ends of the pair of left and right bumper beam extensions 25 and 25, which are made of a CFRP and extend from the pair of left and right front side frame extremity parts 24 and 24 toward the front of the vehicle body, in this state the outer faces in the vehicle width direction and the front faces of the pair of left and right lower members 27 and 27, the front end faces of the pair of left and right bumper beam extensions 25 and 25, and the front face of the bumper beam 29 form a shape that is curved into a U-shape pointing toward the front of the vehicle body when viewed from above.

In this way, due to the use of a CFRP as much as possible, not only is it possible to reduce the weight of the vehicle body frame in the front part of the motor vehicle, but it is also possible to transmit to the bumper beam extensions 25 and 25 the load of a frontal collision, inputted even into the bumper beam 29 or inputted even into the front parts of the lower members 27 and 27, thus absorbing the collision load and, moreover, since the bumper beam 29 does not protrude from the lower members 27 and 27 toward the front of the vehicle body, it is possible to reduce the dimensions of the vehicle body front part.

That is, in FIG. 10, if a collision load F1 when there is a frontal collision is inputted into the bumper beam 29, the collision load F1 is transmitted from the bumper beam 29 to the left and right bumper beam extensions 25 and 25 and efficiently absorbed by crumpling of the bumper beam extensions 25 and 25, which are impact absorbing members. Furthermore, if a collision load F2 when there is a narrow offset frontal collision is inputted into the front part of the left or right lower member 27, the collision load F2 is transmitted from the lower member 27 to the left or right bumper beam extension 25 and efficiently absorbed by crumpling of the bumper beam extension 25, which is an impact absorbing member. Moreover, if a collision load F3 when there is an offset frontal collision is directly inputted into the front end of the left or right lower member 27, the collision load F3 is efficiently absorbed by crumpling of the bumper beam extension 25, which is an impact absorbing member.

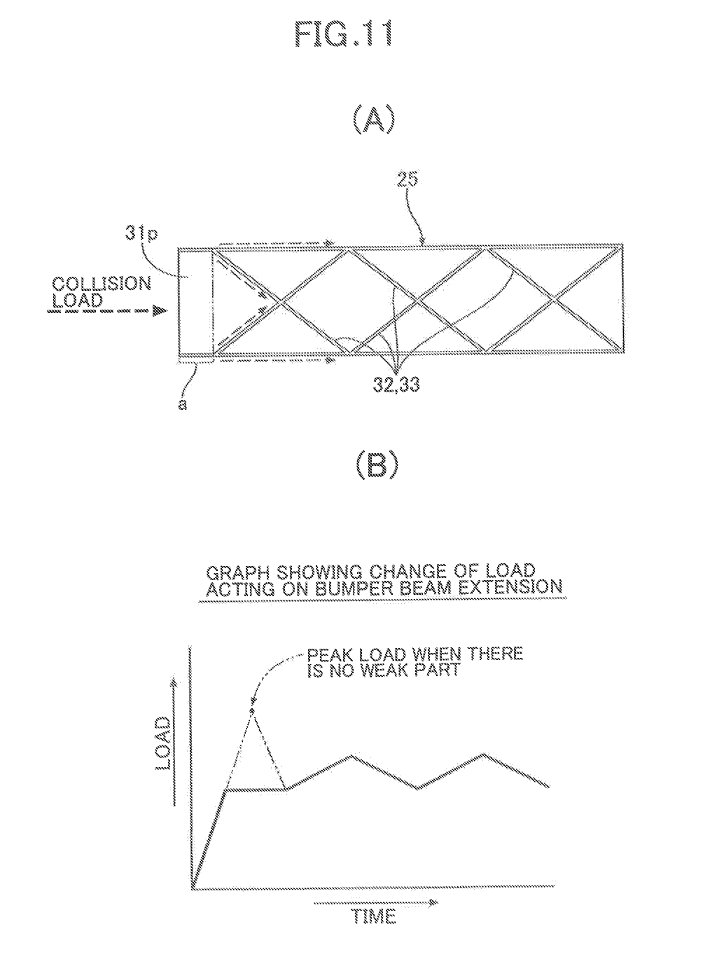

As shown in FIG. 11, when the bumper beam extension 25 crumples due to a collision load from the front, since the first and second ribs 32, 33 are not provided on the weak portion 31p, which spans the length a of the extremity of the main body part 31, the weak portion 31p readily buckles, thus reducing the initial peak load of the collision.

Furthermore, since the bumper beam 29, the lower member 27, and the bumper beam extension 25 include the main body parts 40, 34, and 31 formed by hardening the continuous fibers 44A, 44B with a resin so as to have an open cross section, and the ribs 41, 42, 38, 39, 32, and 33 that are formed by hardening the discontinuous fibers 45 with a resin and that provide a connection between the inner faces of the main body parts 40, 34, and 31, it is possible to achieve a balance between strength and moldability by reinforcing the main body parts 40, 34, and 31 having a relatively simple shape with the continuous fibers 44A, 44B having high strength and reinforcing the ribs 41, 42, 38, 39, 32, and 33 having a relatively complicated shape with the discontinuous fibers 45 having high moldability. As a result, opening of the jaws of the main body parts 40, 34, and 31 having an open cross section can be prevented by means of the ribs 41, 42, 38, 39, 32, and 33, thereby giving high strength with a lightweight structure.

In particular, since the bumper beam 29 and the lower member 27 have the plurality of vertical ribs 42, 39 in the interior of the main body parts 40 and 34 having a squared U-shaped cross section, the strength against twisting or bending of the main body parts 40 and 34 can be enhanced by means of the vertical ribs 42, 39, and collision energy can be efficiently absorbed by the main body parts 40 and 34 and the vertical ribs 42, 39 being sequentially crumpled from the end side by the collision load.

Furthermore, with regard to the bumper beam extension 25, since the pluralities of first and second ribs 32, 33 are provided along the vehicle body fore-and-aft direction in the interior of the main body part 31 having an S-shaped cross section, it is possible to absorb collision energy with a stable load over a long period from the initial time of collision to the final time of collision while holding down the peak load to a low level and, moreover, since the position in the vehicle body fore-and-aft direction of the X-shaped intersection point of the first ribs 32 is made to coincide with the position in the vehicle body fore-and-aft direction of the X-shaped intersection point of the second ribs 33, it is possible to crumple the impact absorbing member stepwise from the extremity side while more reliably preventing opening of the jaws of the main body part 31 of the impact absorbing member by means of the first and second ribs 32, 33.

Furthermore, since the second side wall 31b of the main body part 31 of the bumper beam extension 25 has a draft angle in the vehicle width direction, the bumper beam extension 25 can easily be removed from the mold.

Since each lower member 27 includes the first portion 34a extending downwardly toward the front from the front end of the upper member 22, the second portion 34b bending via the first bent portion 34d at the front end of the first portion 34a and extending forwardly in the horizontal direction, and the third portion 34c bending inwardly in the vehicle width direction via the second bent portion 34e at the front end of the second portion 34b and connected to the front end of the bumper beam extension 25, when there is a narrow offset frontal collision, if a collision load in the fore-and-aft direction is inputted into the front end of the lower member 27, there is a possibility that the lower member 27 would fold back via the first and second bent portions 34d and 34e and the collision load would not be able to be absorbed effectively.

However, since each lower member 27 includes the main body part 34 having a squared U-shaped cross section opening outwardly in the vehicle width direction while having the bottom wall 35 and the first and second side walls 36 and 37, and the horizontal rib 38 and the vertical ribs 39 providing a connection between the bottom wall 35 and the first and second side walls 36 and 37, the bottom wall 35 is formed from a continuous fiber-reinforced resin in which the continuous fibers 44A, 44B are hardened with a resin, and the first and second side walls 36 and 37, the horizontal rib 38, and the vertical ribs 39 are formed from a discontinuous fiber-reinforced resin in which the discontinuous fibers 45 are hardened with a resin, even if the collision load acts so as to fold back the first bent portion 34d, which is bent in the vertical direction, the continuous fiber-reinforced resin of the bottom wall 35 provides resistance thereto, and the first and second side walls 36 and 37, the horizontal rib 38, and the vertical ribs 39 also provide resistance thereto, thus preventing the first bent portion 34d from breaking. Furthermore, even if the collision load acts so as to fold back the second bent portion 34e, which is bent in the left and right direction, the first and second side walls 36 and 37, the horizontal rib 38, and the vertical ribs 39 provide resistance thereto, thus preventing the second bent portion 34e from breaking.

This enables the lower member 27 to be sequentially crumpled from the front side toward the rear side by means of the load of a frontal collision, thus absorbing the collision load effectively. Moreover, since the bottom wall 35 of the lower member 27 curves only in the second bent portion 34e, the lower member 27 can be press formed using a mold.

Since the ribs of each lower member 27 are formed in a lattice shape with the horizontal rib 38 extending along the longitudinal direction of the lower member 27 and the plurality of vertical ribs 39 intersecting the horizontal rib 38, it is possible to reinforce effectively the main body part 34 of the lower member 27 while lightening the weight by reducing the thickness of the horizontal rib 38 and the vertical ribs 39, thereby enabling the main body part 34, the horizontal rib 38, and the vertical ribs 39 to be crumpled by a collision load to thus absorb the collision energy.

Furthermore, since one of the plurality of vertical ribs 39 is disposed in the first bent portion 34d for reinforcement, when a large bending moment is applied to the first bent portion 34d due to the load of an offset frontal collision, it is possible to prevent the lower member 27 from breaking via the first bent portion 34d, thus ensuring the impact absorption performance. Moreover, since the horizontal rib 38 is connected to the bottom wall 35 and extends rearwardly from the front end of the lower member 27, due to the high strength bottom wall 35, which is reinforced with the continuous fibers 44A, 44B, being further reinforced with the horizontal rib 38, when the load of an offset frontal collision is inputted into the front end of the lower member 27, it is possible to prevent the lower member 27 from breaking via the first bent portion 34d or the second bent portion 34e, thus ensuring the impact absorption performance.

Furthermore, since the second mounting flange 34g is provided at the front end of the lower member 27, the front end of the lower member 27 can easily be connected to the front end of the bumper beam extension 25. Moreover, since the second mounting flange 34g is formed from a discontinuous fiber-reinforced resin in which the discontinuous fibers 45 are hardened with a resin, the main body part 34 and the second mounting flange 34g of the lower member 27 can be molded all at once, thus enabling the number of processing steps to be cut.

An embodiment of the present invention is explained above, but the present invention may be modified in a variety of ways as long as the modifications do not depart from the spirit and scope thereof.

For example, the fiber-reinforced resin of the present invention is not limited to a CFRP, and an FRP reinforced with any fiber may be used.

Furthermore, in the embodiment the bumper beam 29 and the lower member 27 are connected to the front end of the bumper beam extension 25, but it is not always necessary for the lower member 27 to be connected to the bumper beam extension 25.

Moreover, the outer end in the vehicle width direction of the bumper beam 29 and the inner end in the vehicle width direction of the lower member 27 may be directly connected, and a rear face of the bumper beam 29 or a rear face of the lower member 27 may be supported by a front end face of the bumper beam extension 25.

1-8. (canceled)

9. A vehicle body frame structure of a motor vehicle in which a bumper beam disposed in a vehicle width direction is connected to an impact absorbing member made of a fiber-reinforced resin and disposed in a vehicle body fore-and-aft direction, and a collision load inputted into the bumper beam is absorbed by crumpling of the impact absorbing member, wherein
a main body part of the impact absorbing member is formed so as to have an S-shaped cross section while comprising a first side wall, a second side wall and a third side wall, which are disposed substantially parallel to each other, a first bottom wall connecting end parts on one side of the first side wall and the second side wall, and a second bottom wall connecting end parts on the other side of the third side wall and the second side wall,
the first side wall, the first bottom wall and the second side wall being connected via a first rib forming an X-shape when viewed in the vehicle width direction, and the third side wall, the second bottom wall and the second side wall being connected via a second rib forming an X-shape when viewed in the vehicle width direction.

10. The vehicle body frame structure of a motor vehicle according to claim 9, wherein the main body part of the impact absorbing member is formed from a continuous fiber-reinforced resin in which continuous fibers are hardened with a resin, and the first and second ribs are formed from a discontinuous fiber-reinforced resin in which discontinuous fibers are hardened with a resin.

11. The vehicle body frame structure of a motor vehicle according to claim 10, wherein the first and second ribs are provided as pluralities along a vehicle body fore-and-aft direction.

12. The vehicle body frame structure of a motor vehicle according to claim 9, wherein the position in the vehicle body fore-and-aft direction of an X-shaped intersection point of the first rib coincides with the position in the vehicle body fore-and-aft direction of an X-shaped intersection point of the second rib.

13. The vehicle body frame structure of a motor vehicle according to claim 9, wherein front ends of the first and second ribs are positioned to the rear of the front end of the impact absorbing member by a predetermined distance.

14. The vehicle body frame structure of a motor vehicle according to claim 9, wherein the second side wall has a draft angle in the vehicle width direction for removal from a mold.

15. The vehicle body frame structure of a motor vehicle according to claim 9, wherein the impact absorbing member is connected to a front end of a lower member extending forwardly from an upper member disposed above a wheel house, and the lower member comprises a first portion extending downwardly toward the front from the front end of the upper member, a second portion bending via a first bent portion at a front end of the first portion and extending forwardly in a horizontal direction, and a third portion bending toward the inner side in the vehicle width direction via a second bent portion at a front end of the second portion and connected to the front end of the impact absorbing member,
the lower member comprises a main body part having a squared U-shaped cross section opening outwardly in the vehicle width direction while comprising a bottom wall and a pair of side walls, and comprises a plurality of ribs connecting the bottom wall and the pair of side walls, the bottom wall is formed from a continuous fiber-reinforced resin in which continuous fibers are hardened with a resin, and the pair of side walls and the ribs are formed from a discontinuous fiber-reinforced resin in which discontinuous fibers are hardened with a resin.

16. The vehicle body frame structure of a motor vehicle according to claim 15, wherein the ribs are formed into a lattice shape with a horizontal rib extending along a longitudinal direction of the lower member and a plurality of vertical ribs intersecting the horizontal rib.

17. The vehicle body frame structure of a motor vehicle according to claim 16, wherein one of the vertical ribs is disposed in the first bent portion.

18. The vehicle body frame structure of a motor vehicle according to claim 16, wherein the horizontal rib is connected to the bottom wall and extends rearwardly from the front end of the lower member.

19. The vehicle body frame structure of a motor vehicle according to claim 15, wherein the lower member comprises a flange at the front end for connection to the front end of the impact absorbing member, and the flange is formed from a discontinuous fiber-reinforced resin in which discontinuous fibers are hardened with a resin.

20. The vehicle body frame structure of a motor vehicle according to claim 9, further comprising a lower member, wherein the bumper beam, the lower member and the impact absorbing member comprise a main body part having an open cross section and a rib connecting inner faces of the main body part, the main body part is formed by hardening continuous fibers with a resin, and the rib is formed by hardening discontinuous fibers with a resin.

21. The vehicle body frame structure of a motor vehicle according to claim 20, wherein the bumper beam and the lower member comprise a plurality of vertical ribs in an interior of the main body part having a squared U-shaped cross section.

22. The vehicle body frame structure of a motor vehicle according to claim 20, wherein the impact absorbing member comprises a plurality of X-shaped ribs in an interior of the main body part having an S-shaped cross section.
